(19) United States
(12) Patent Application Publication
(10) Pub. No.: US 2007/0264621 A1
(43) Pub. Date: Nov. 15, 2007

(54) Chest simulator

(75) Inventors: Jon Nysaether, Hafrsfjord (NO); Ivan Rafoss, Sandnes (NO)

Correspondence Address: NIXON & VANDERHYE, PC, 901 NORTH GLEBE ROAD, 11TH FLOOR, ARLINGTON, VA, 22203, US

(73) Assignee: Laerdal Medical AS, Stavanger (NO)

(21) Appl. No.: 11/797,907

(22) Filed: May 8, 2007

(30) Foreign Application Priority Data
May 10, 2006 (NO) 2006 2108

(51) Int. Cl. G09B 23/28

(52) U.S. Cl. 434/262

(57) ABSTRACT

A CPR training manikin for simulating realistic conditions, having a first part for receiving applied pressure and movement from the user, and a second part for positioning on a supporting surface, said first and second parts being separated by an elastic element and guiding means for providing an essentially linear movement between the parts, the training device also comprising a piston containing a fluid providing a dampened movement between said parts in the direction of said linear movement.

### CROSS REFERENCE TO RELATED APPLICATION

This application is based upon, claims the benefit of, priority of, and incorporates by reference, the contents of Norweigan Patent Application No. NO 2006 2108 filed May 10, 2006.

### BACKGROUND OF THE INVENTION

This invention relates to a manikin with realistic chest properties for practicing chest compressions

The ILCOR/AHA Guidelines (Guidelines 2000 for Cardiopulmonary Resuscitation and Emergency Cardiovascular Care. Supplement to Circulation 2000; 102: I 22-59) recommend a chest compression depth of 38 to 51 mm during cardiopulmonary resuscitation (CPR). CPR training is often performed on manikins with a spring loaded chest. The manikin is normally made with a linear spring, i.e. a spring where depth increases linearly with the applied force.

Published data on chest stiffness however cast doubt on how well manikins with a linear spring actually mimic the elastic properties of a human chest.

Tsitlik et al (Tsitlik et al, Elastic Properties of the Human Chest during Cardiopulmonary Resuscitation, Critical Care Medicine, Vol 11, No 9 p 685-692 (1983)) measured the sternal displacement and force during CPR in 11 adults and 2 manikins. He concluded that while manikins have a linear relationship between force and compression depth, the relationship for humans is non-linear. For low displacements, the stiffness of the manikin is also much higher than for a human chest.

Gruben (Gruben, K, Mechanics of Pressure Generation during Cardiopulmonary Resuscitation, Ph D Thesis, John Hopkins University, Baltimore, Maryland, (1993)) measured the compression force and compression depth of 16 cardiac arrest patients and 5 CPR manikins. Like Tsitlik, Gruben found a strong non-linear behaviour of chest stiffness, and a significant difference between humans and manikins. In addition, Gruben reported a viscous damping force which increased with compression depth.

In contrast to a purely elastic spring, a damped system will consume energy from the rescuer during CPR, and thus be more tiresome.

To make CPR training more realistic and thereby enhance the knowledge about BLS (basic life support) in the population, it would be an advantage to construct a manikin with mechanical properties more close to actual properties found in the population.

Several solutions have been suggested to simulate the chest of a patient for training purposes. One example is described in US patent application No 2005/0058977, which describes the use of a spring with a chosen flexibility, being positioned in a cylindrical guide so as to guide the movements applied to the device. This is a simple device but does not provide an efficient simulation of a real chest as it lacks means for simulation the resistance in both upward and downward movements. Other devices are described in U.S. Pat. No. 4,601,665 describing an electromagnetic device, U.S. Pat. No. 5,423,685, describing the use of a resilient foam and U.S. Pat. No. 4,984,987 and U.S. Pat. No. 5,249,968 describing the use of a bellows. Neither of these provides a very efficient in simulating the complex resistance and flexibility of the chest, and are thus unsuitable for some uses, especially for the use described in the simultaneously Norwegian patent application 2006 2107 filed on 10 May 2006, which describes a system and method for using manikins in stead of people for verifying the quality of CPR measuring and feedback devices.

### SUMMARY OF THE INVENTION

It is an aim of this invention to describe a manikin for CPR training, the manikin having mechanical properties that resemble actual properties found in a population or a part of a population. The objects stated above are obtained using a CPR training manikin for simulating realistic conditions being characterized as stated in the independent claim.

### BRIEF DESCRIPTION OF THE DRAWINGS

The invention will be described below with reference to the accompanying drawings, illustrating the invention by way of example.

FIG. 1 shows a schematic drawing of the mechanical elements of the invention, including a progressive elastic element (spring) and a damping mechanism.

FIG. 2 shows a cross-sectional view of an example embodiment of the invention.

FIG. 3 illustrates a more complex version of the embodiment illustrated in FIG. 2.

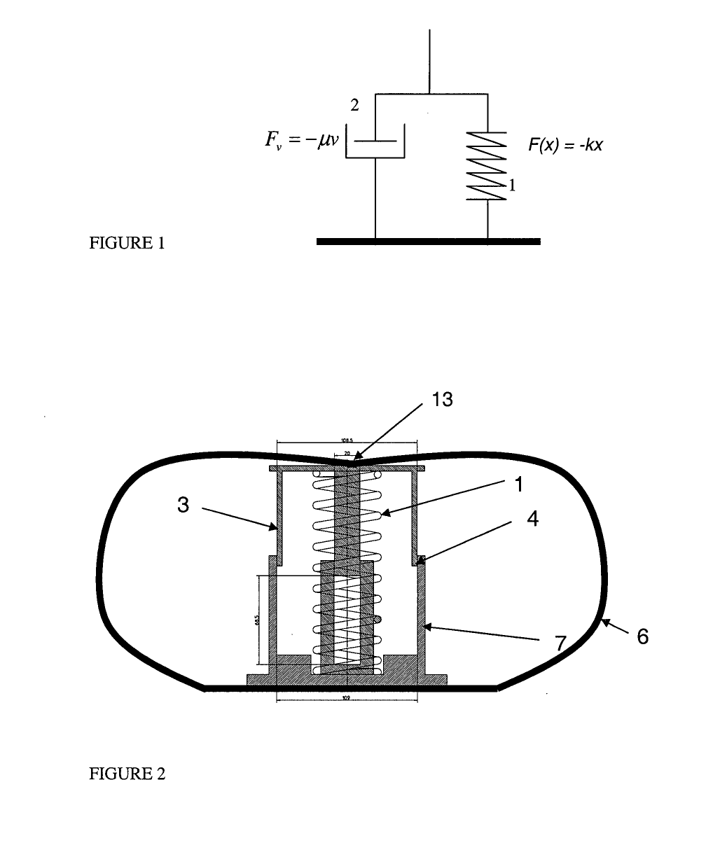

### DETAILED DESCRIPTION OF THE INVENTION

In this embodiment, the manikin comprises an elastic element 1 (e.g. a spring) with non-linear properties, so that the stiffness k=dF(x)/dx of the manikin varies with depth x. F(x) is here the force needed to compress the manikin's chest to a depth x. The elastic element is mounted in the manikin 6, for instance directly below the recommended hand position for chest compressions. Preferably, the elastic element 1 is a mechanical spring.

The stiffness characteristic of the spring is chosen so that when the spring is mounted in the manikin, the stiffness characteristics of the manikin chest resembles a reference characteristics representative of the whole or a part of a population.

These reference characteristics may for instance be derived statistically from experimental measurements of chest stiffness characteristics on human subjects. Such experiments may for instance be carried out using a chest compression sensor measuring both the applied compression force and obtained compression depth as a function of time. Such sensors are available in the market.

To estimate stiffness from measurements of force and depth, the viscous component of the force must first be subtracted from the total force, for instance by assuming a viscous damping parameter being dependent of depth and giving rise to a damping force proportional to the speed of the chest (F_v=μv, where F_v is the viscous force, μ is the damping parameter and v the speed of the chest). The value of μ at different depths can be estimated by observing the width of the hysteresis loop in the force-depth curve. In a similar manner, the friction forces, being dependent only on the direction of movement and not the speed, may be subtracted. The moving mass of the chest, giving rise to inertial forces, can also be estimated by correlating acceleration and force, for instance near the minimum or maximum points of compression where the viscous force is low.

Based on such stiffness measurements, the reference characteristics of the spring may be chosen so that the spring represents a specific part of the population.

For instance, the population may be grouped in n groups in order of increasing stiffness. One spring type may then be defined for each group, so that the n springs range in stiffness from “softest chest” to “stiffest chest”. To change between spring types in a training situation, the n springs may for instance be interchangeable in the manikin itself, or there may be one manikin for each group. The number of groups can for instance be between 1 and 20.

In one embodiment, the manikin comprises a damping component 2. Preferably, the damping mechanism is predominantly viscous, so that it supplies a force Fᵥ against the movement being proportional to the speed v of the chest during compression.

Preferably, to better match actual chest properties, the damping coefficient μ=Fᵥ/v varies with compression depth. Preferably, the viscous medium in the damper is air, water or oil.

In a most preferable embodiment of this invention, the damper mechanism is a piston 3 with a surrounding cylinder 7 or equivalent filled with air, in which there is a flow restriction 4 limiting the flow of air between the interior of the cylinder and the ambient. The flow restriction 4 can for instance have form as a narrow gap between the piston outer diameter and the cylinder inside diameter.

The volume of the air-filled interior of the cylinder 7 is determined by the position of the piston 3. The position of the piston 3 is preferably related to the position of the chest surface 5, so that when the latter is under compressions, the volume inside the cylinder changes. Due to the restriction 4 through which air has to pass to reach ambient pressure, this change in volume will create an under- or overpressure inside the cylinder 7, depending on whether the chest moves up or down.

The force Fᵥ acting against the movement is then approximately Fᵥ=pA, where A is the area of the piston and p the pressure difference vs ambient. Preferably, the area of the piston is at least 10 cm², so that the necessary forces are obtained at relatively modest over- or underpressures.

Preferably, to allow for a variable damping component, the flow resistance of the restriction varies with compression depth. This can for instance be obtained by letting the length of the restriction 4 correspond to the position of the piston 3, as is the case with the embodiment shown in FIG. 2.

The damping characteristic is so that when the damper is mounted in the manikin, the damping of the manikin chest resembles a reference characteristics representative of the whole or a part of a population. As for stiffness, the reference damping may for instance be derived from experimental measurements of chest damping characteristics on human subjects as described above.

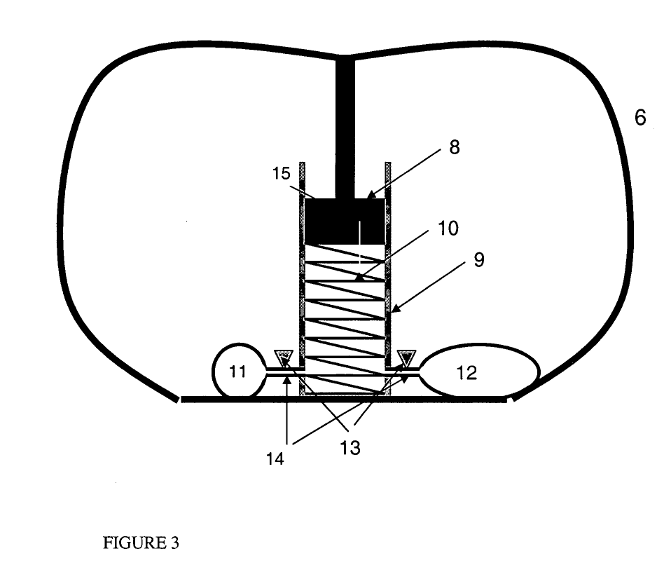

In another embodiment, shown in FIG. 3, the variable spring element 1 is obtained by compression of air, for instance by a piston 8 in a cylinder 9. Inside the cylinder 9, or in other volumes 11-12 coupled to the cylinder, there is a closed volume filled with air.

The piston 8 is preferably fixed to the moving part of the manikin chest 6, so that when the manikin chest surface moves up and down under compressions, the air volume in the cylinder 9 (and connected volumes 11-12) is compressed. The pressurized air will then act on the piston 8 with a force F given by the area A of the piston 8 and the overpressure p inside the cylinder 9:

F=pA, where p is the overpressure relative to ambient pressure p₀.

Assuming constant temperature, the force on the piston 8 as a function of displacement x will be given by:

$$F ( x ) = p ( x ) A = {p}_{0} \frac{{V}_{0} A}{V ( x )} = \frac{Al + {V}_{ext}}{( l - x ) + {V}_{ext} / A} \qquad ( 1 )$$

Here, l is the position of the piston 8 relative to the bottom of the cylinder 9 when the force on the piston 8 is zero, and x is the displacement of the piston 8 from this position. Vₑₓₜ is the volume of any other, external volumes 11-12 being in flow contact with the cylinder. V(x) is the volume of the entire system as a function of piston displacement and V₀ is the volume when x is zero.

As can be seen from equation 1, the larger the external volume, the smaller the stiffness dF/dx of the spring will be. To be able to switch the stiffness of the manikins between different patient characteristics (for instance representing soft patient chests, medium chests and stiff chests), it is possible to connect the cylinder to the different, selectable volumes 11-12, for instance by the help of valves 13.

In FIG. 3 a schematic system with 2 external volumes 11-12, is shown. By closing all valves 13, or by having only the valve to the small volume 11 open, the manikin chest will be relatively stiff. By opening the connection to the largest volume 12, or to both volumes, the manikin chest will be softer. To achieve viscous damping in this system, the connection tubes 14 to the external volumes may be so small that they act as flow restrictions.

It is also possible to split the two functionalities (spring 1 and damper 2) in two parallel, independent systems.

If the temperature changes in the cylinder 9 for any reason, for instance as an effect of ambient temperature changes or as a result of heating due to compression being performed, the air volume inside the cylinder 9 (and connected volumes 11-12) will change, and so also the zero force piston position. To solve this, it is possible to vent the cylinder through a small opening 15. The opening must be so small that the typical time constant for air passing through the opening is larger than typical compression time constants, yet so large than the time constant is smaller than the relevant thermal time constants of the system.

If the system is vented, the assembly will however not act as a spring under static conditions. Air will be pressed out by the weight of the piston which will eventually slide down to the bottom of the cylinder. This can for instance be solved by means of a spring 10 inside (or outside) the cylinder, with the purpose of holding the piston in place under static conditions. The spring can for instance be a conic spring so that it can be compressed to zero length to save place.

The spring 10 will also add to the overall stiffness of the system under dynamic conditions (i.e compressions). The piston can also be held up by generating a slight overpressure in the piston, e.g by means of a compressor. In this case a venting hole may not be needed. Instead, there may be a mechanical stop limiting the movement of the piston upwards.

To summarize the invention it relates to a CPR training manikin for simulating realistic conditions, having a first part for receiving applied pressure and movement from the user, and a second part for positioning on a supporting surface, said first and second parts being separated by an elastic element and guiding means for providing an essentially linear movement between the parts, the training device also comprising a piston containing a fluid providing a dampened movement between said parts in the direction of said linear movement. The piston preferably contains at least one opening for controlled passage of said fluid, so as to provide a dampening to the movement imposed by the spring and user, and may also constitute the guiding means of the manikin.

The fluid in the piston is preferably air, but in some cases oil or water or other gases may be used, requiring some kind of container collecting the fluid outside the passage. If this container is flexible, e.g. like a balloon, it may ad to the resistance in the system.

The opening may be provided as a slit or similar in the piston so that the relative position of the parts also has an effect on the size of the opening, e.g. resulting in a resistance being proportional to the distance between said parts. Using a valve on said passage may provide a possibility to adjust the resistance. An alternative is to allow an fluid flow in a gap 4 between the piston parts. If these have slightly varying dimensions this gap may vary with the piston movement.

As mentioned above the characteristics of the manikin according to the invention is are chosen according to data representing characteristics of a chosen part of the population, so as to simulate a real person. This is especially useful when using the manikin for qualifying CPR response equipment. In order to adjust the manikin for representing different parts of the population the relevant parts are adjustable or replaceable so as to enable adaptation of the device to simulate different parts of the population.

The elastic element may be provided in different ways, e.g. being constituted by a spring, a gas-filled piston or a combination of these, depending on the characteristics to be simulated. Using a gas-filled piston it is possible to adjust the element by adjusting the volume connected to said piston. For regulating temperature the piston may be connected to ambient pressure through a small opening in order to reduce pressure variations in the piston related to temperature.

1. CPR training manikin for simulating realistic conditions, having a first part for receiving applied pressure and movement from the user, and a second part for positioning on a supporting surface, said first and second parts being separated by an elastic element and guiding means for providing an essentially linear movement between the parts, the training device also comprising a piston containing a fluid providing a dampened movement between said parts in the direction of said linear movement.

2. Device according to claim 1, wherein said piston comprises at least one opening for controlled passage of said fluid.

3. Device according to claim 2 wherein said fluid is air.

4. Device according to claim 2, wherein the flow resistance of said opening is dependent on the relative position between said parts, e.g. its resistance being proportional to the distance between said parts.

5. Device according to claim 2, wherein said at least one opening leads to a second container, thus receiving said fluid when pressed through said opening.

6. Device according to claim 5, wherein said second container is flexible, thus providing a resistance to fluids pressed into it.

7. Device according to claim 1, wherein the characteristics of said device is chosen according to data representing characteristics of a chosen part of the population, so as to simulate a real person.

8. Device according to claim 7, wherein the relevant parts of the device are adjustable or replaceable so as to enable adaptation of the device to simulate different parts of the population.

9. Device according to claim 1, wherein said guiding means are constituted by said piston.

10. Device according to claim 1, wherein said elastic element is constituted by a spring.

11. Device according to claim 1, wherein said elastic element is constituted by a combination of a gas-filled piston and a spring.

12. Device according to claim 1, wherein said elastic element is constituted by a gas-filled piston.

13. Device according to claim 11, wherein the stiffness of said elastic element is adjustable by adjusting the volume connected to said piston

14. Device according to claim 13, wherein said piston is connected to ambient pressure through a small opening in order to reduce pressure variations in the piston related to temperature.
